(19) United States
(12) Patent Application Publication
(10) Pub. No.: US 2013/0280978 A1
(43) Pub. Date: Oct. 24, 2013

(54) INSULATION WITH MEMBRANE LAYER ADDED TO NON-WOVEN FIBERFILL PADDING

(71) Applicants: Ming Wai Anderson Lee, Kowloon (HK); Adelbert Ming Pak Lee, Kowloon (HK)

(72) Inventors: Ming Wai Anderson Lee, Kowloon (HK); Adelbert Ming Pak Lee, Kowloon (HK)

(73) Assignee: PINNECO RESEARCH LIMITED, Tsim Sha Tsui (HK)

(21) Appl. No.: 13/454,561

(22) Filed: Apr. 24, 2012

(51) Int. Cl. B32B 5/02; B32B 27/12; B32B 37/12; B32B 27/02; D04H 13/00; B32B 5/26

(52) U.S. Cl. 442/381; 442/327; 442/395; 156/60

(57) ABSTRACT

Insulation and method for making it which bonds fiberfill padding to a membrane is disclosed. Moisture along with heat is transferred from the user of the insulated product to the insulation. The membrane allows the transfer of this moisture to the surrounding air. A novel way of binding polyester padding to a polyester membrane using polyurethane as the adhesive is accomplished by using a solvent to melt the polyurethane.

### BACKGROUND

Fiberfill is a material commonly found in many consumer products today. Ranging from insulated clothing, outdoor/camping equipment, even in housing insulation, all make very good use of some form of synthetic fiberfill material. Each of the above products' primary focus is to provide thermal protection for the consumer.

Fiberfill is made up of Polyester fibers. By mixing various types of Polyester fibers, one can generate a thin sheet of non-woven layer. Stacking the many layers together and utilizing various processing procedures result in a non-woven structure in the form of a padding roll. Since the finishing product often exists in roll, fiberfill is also known as Polyester Padding.

Fiberfill is widely regarded as one of the most versatile insulation materials due to the availability of the Polyester fibers and minimal manufacturing technique required. Polyester fiber is a by-product of crude oil and thus is readily available in the market. The manufacturing process in turning fiber to padding is machine-dependent requiring minimum technical know-how. Technically, anyone with proper machinery is able to make some basic form of fiberfill/Polyester padding.

The functioning mechanism of fiberfill padding is as follow:

The inter-networking of the fibers in a non-woven layer generates a lot of empty spots. These spots are really just empty space. The stacking of non-woven layers to achieve a certain thickness of the fiberfill padding, turns the empty spots into air pockets. The trapped air slows down the air movement from one side of the fiberfill to the other. The trapping of warm air in the air pockets allows for the exchange of heat energy between the warm air and the fiberfill structure. Polyester, being a modest heat conductor, picks up and releases heat rather quickly. As a result, by slowing down the air movement and providing the platform for the heat energy exchange, fiberfill is able to act as a heat container/reservoir and thus being a very effective insulation material.

There are 3 factors affecting the performance ability in a fiberfill padding:
1. The thickness of an individual Polyester fiber. The smaller the fiber, the easier it is for the heat exchange to take place.
2. The density of the non-woven structure. The higher the density leads to more empty spots and thus more air pockets.
3. The thickness of the padding (loft). Multiple layers of non-woven sheets form the padding. The thicker the padding, the harder it is for the air (warm) to get through.

Theoretically, the most efficient fiberfill is made of small Polyester fiber in a high-density structure with good loft. However, in reality, there is another aspect of nature that brings negative impact to such product: moisture saturation.

Body heat energy often is released in the form of perspiration, which most often condenses within the synthetic padding structure. Although Polyester does not absorb water, the condensation affects the air-trapping ability by reducing the surface area/volume available for the heat transfer process. The faster the evaporation occurs (ridding of moisture in the padding), the better the thermal performance a synthetic padding has. The problem is that the evaporation process is really a passive mechanism which it is very weather dependent. In rainy conditions (high humidity), the evaporation is hardly effective as the resident air is already saturated with water content. The thermal performance of a fiberfill padding is thus reduced.

A higher density non-woven structure contains more small air pockets, which trap more heat. However, the finer the air space also leads to more condensation due to capillary action. Once condensation sets in, there are less functional air pockets available which prevents the fiberfill padding from performing at its optimum potential. As a result, the actual thermal performance of any given fiberfill padding is requires finding a good balance between preserving heat and minimizing condensation.

### SUMMARY

All of the so-called higher performance fiberfill paddings available in the market primarily focuses on improving the heat preserving aspect of the padding. Moisture management is very much an afterthought. Incorporating a waterproof/breathable membrane layer with a fiberfill padding surface provides thermal protection while managing the moisture. A novel means of bonding the membrane layer and fiberfill padding together is disclosed.

### BRIEF DESCRIPTION OF DRAWINGS

FIG. 1 shows the normal fiberfill padding and the disclosed insulation.

FIG. 2 depicts the transfer of heat and moisture from a user through the transfer of water ultimately to surrounding air.

FIG. 3 shows a possible arrangement for assembly of the disclosed product and method.

### DETAILED DESCRIPTION

Synthetic membranes are commonly used in material for filtration/separation purposes in laboratory and industrial uses. A typical membrane structure consists of a number of pores acting as a gateway to let particles that are smaller than the pore freely to go through. Membranes, for textile use, come in the form of PU (polyurethane), PTFE (polytetrafluoroethylene), or PE (Polyester).
PU (polyurethane) is the most commonly used membrane, mostly due to the wide selection of pore size and the ease of implementation to various materials. The problem is, it is subject to oxidation where the lamination will deteriorate over time, making the PU membrane based product less durable.
PTFE (polytetrafluoroethylene) is more durable than PU and its permeability is very high due to its micro-porous structure. But it also has a longevity issue since the pores are so tiny that it is prone to blockage. This decrease in permeability results in decrease in performance.
PE (Polyester) is both durable and very permeable. But PE is very difficult to use compared to PU and PTFE and thus Polyester membrane is rarely used.

This invention discloses laminating a layer of a PE based membrane layer to the surface of fiberfill padding. The term “lamination” is common term in the textile industry to describe bonding of any two particular materials together. Membranes have been widely used in apparel fabrics. GORE-TEX® fabric is an example of such where a layer of PTFE membrane is bonded to the underside of a fabric. But laminating a membrane layer to a fiberfill has never been done before for the following reasons:
1. Unlike fabric which has a flat surface made up of an organized weaving of yarns, fiberfill surface not flat and smooth. The randomness of the fibers in a fiberfill padding make lamination very difficult as the membrane will have great difficulty adhering to a padding surface and thus the membrane will most likely fall off from the padding after the lamination.
2. Polyester is a relatively inert material which does not mix well with other material. This also explains why PE membrane is rarely used since its chemical nature is not very compatible with others. If laminating a PE membrane with fabric is a difficult task, and laminating it with fiberfill padding is even more difficult.

The intention of any existing laminated product in the textile industry is to add a waterproof capability. Improving thermal efficiency through the use of membrane has not been done due to the difficulties involved in the lamination process.

The laminated padding disclosed herein will be referred to as the core. The core structure consists of a 2 components: a base layer fiberfill padding and a permeable PE (Polyester) membrane. The base layer padding absorbs body heat the same way as in any existing fiberfill padding. Unlike ordinary synthetic padding, perspiration does not condense in the padding structure; instead, it condenses in the membrane layer. Condensed perspiration is able to pass through to the other side of the membrane layer and then evaporate to the open air. Heat energy is a form of radiation without the interference from moisture, the base layer is able to better perform its function, keeping the body heat within the base layer longer and thus making the system warmer. Natural body movement from one user will generate enough outward pressure, which will facilitate the membrane filtration process and push the water molecule to the exterior side of the membrane. The membrane also serves as backbone to the whole fiberfill structure which improves the durability of the padding and the integrity of the air pockets.

The benefit of the core is the separation of heat from moisture and effectively managing each to attain optimum thermal performance potential of a fiberfill padding.

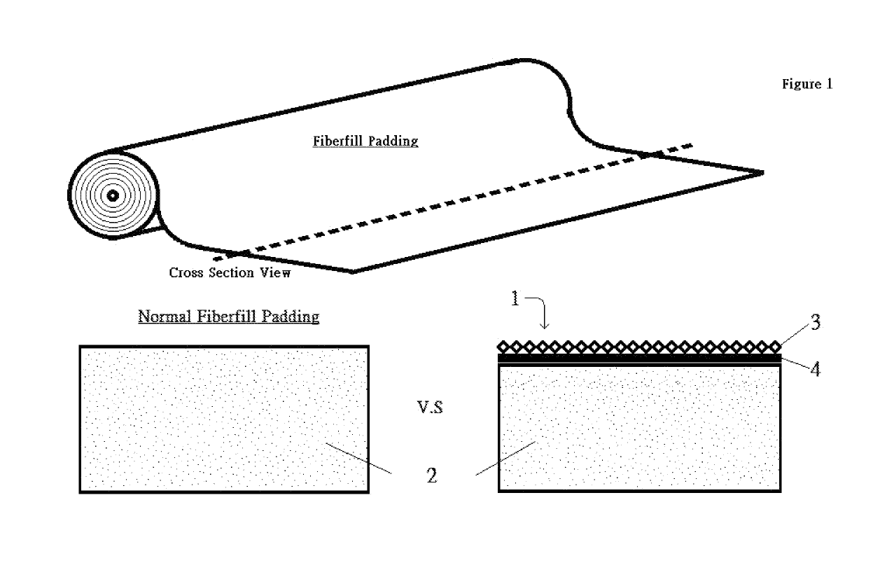

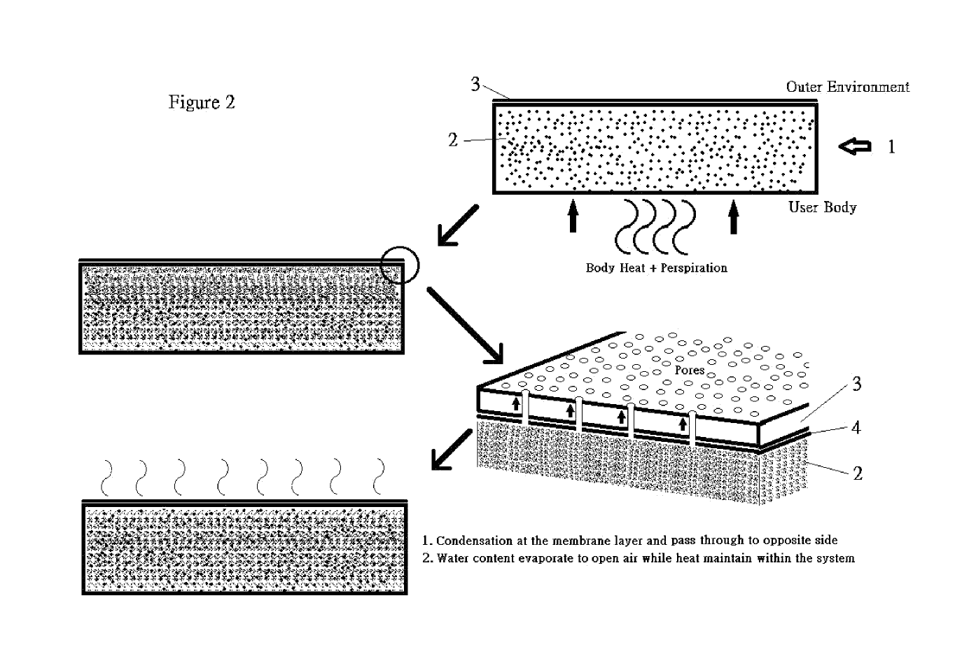

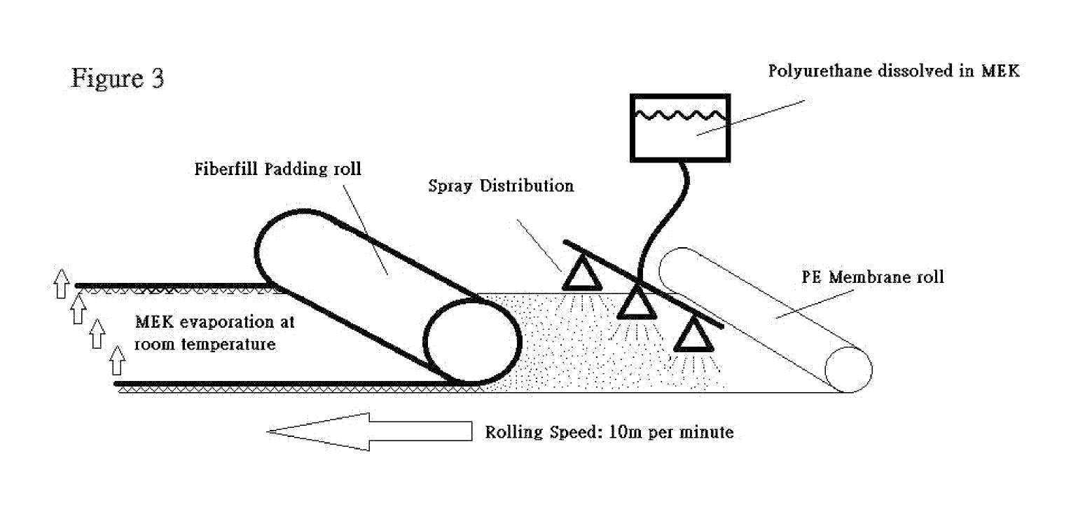

As shown in FIGS. 1-3, the process of laminating a membrane to fiberfill padding to create insulation (1) involves 3 components:

### 1. Fiberfill (2) (Polyester)

### 2. Membrane (3) (Polyester)

3. Adhesive (4) (Polyurethane dissolved in solvent (MEK))

Polyurethane is a very commonly used material for industrial bonding/laminating process. Polyurethane usually comes in the form of a solid block. For it to be used as adhesive, it needs to be melted (by heat) and engraved (pressed) on to the substrate (subject of the lamination). This process generally works very well in a uniform/flat surface lamination, i.e. between a fabric and a membrane; however, this does not work very well when laminating between fiberfill padding and a membrane. After the engraving process, the resulting product is really just a thin fabric like structure with no thickness at all. The trapping of the air (air pockets) is what make fiberfill padding a good insulation material, so it is obvious that traditional lamination process is not applicable in our case.

The method disclosed makes this lamination possible through the use of a chemical solvent called MEK (chemical name=Methyl Ethyl Ketone). Ketone is an organic compound primarily used as an organic solvent. Ketone has a very low boiling point as such that it will evaporate in open air in a matter of seconds. Familiar household uses of Acetone (a form of Ketone) are as the active ingredient in nail polish remover and as paint thinner. Instead of melting the Polyurethane by heat, we use MEK to dissolve the Polyurethane into liquid form. The liquefied Polyurethane (the glue) is then quickly applied to between the membrane and the fiberfill padding. Within 30 seconds, once the MEK solvent evaporates, the Polyurethane is able to bond between the PE membrane and the fiberfill padding, without having to go through the engraving process.

A more detail description of the process as in follow:
1. Fiberfill padding and membrane are set up and ready to be bonded.
2. Polyurethane is dissolved using MEK. Concentration ratio between Polyurethane and MEK typically varies between 30:70 to 55:45. This totally depends on the density of the substrate (fiberfill padding density).
3. The net weight of the liquefied Polyurethane is around 5 to 25 g/m²
4. Liquefied Polyurethane is applied onto the membrane.
5. Gently and quickly apply the fiberfill padding on top of the membrane. Running speed at 5-10 yards per minute allows enough time for evaporation to take place.
6. The product is ready as soon as the solvent evaporates.

The adhesive can be applied by using a sprayer, roller, brush or other means. The adhesive should be uniformly applied to surface of the membrane. The fiberfill must be layered onto the membrane with adhesive immediately after the adhesive is applied.

If there is a technical issue in differentiating (Polyester) fiberfill from (Polyester) fabric, thickness level can be added to the specification. The Polyester fiberfill padding (base layer) typically consists of a minimum 90% Polyester fiber content. A PE (Polyester) membrane typically consists of a minimum 50% Polyester content. The lamination process disclosed can be applied on any given surface of the fiberfill padding, and can include multiple laminations. Other embodiments include 2 fiberfill paddings+1 membrane layer (Fiberfill/Membrane/Fiberfill); 2 membranes+1 fiberfill paddings (Membrane/Fiberfill/Membrane); etc. Fabric is usually no thicker than 1 mm, fiberfill on the other hand will at least have thickness of 5 mm. So this can be added if needed.

Although several embodiments described above and by the claims serve to illustrate various concepts, components and techniques which are the subject of this patent, it is apparent to those of ordinary skill in the art that other embodiments incorporating these concepts, components and techniques may be used. It is understood that the scope of the following claims are not limited to the described embodiments and that many modifications and embodiments are intended to be included within the scope of the following claims. In addition the specific terms utilized in the disclosure and claims are used in a generic and descriptive sense and not for the purpose of limiting the invention described in the following claims.

1. Insulation comprising:
fiberfill padding;
membrane; and
adhesive binding the fiberfill padding to the membrane.

2. Insulation according to claim 1 wherein the fiberfill padding is a non-woven layer of Polyester fibers.

3. Insulation according to claim 2 wherein the fiberfill padding is a minimum of 90% fiber content.

4. Insulation according to claim 3 wherein the membrane is a minimum of 50% Polyester content.

5. Insulation according to claim 4 wherein the adhesive is polyurethane.

6. Insulation according to claim 5 wherein a chemical solvent is utilized to melt the polyurethane.

7. Insulation according to claim 6 wherein the solvent is MEK.

8. Insulation according to claim 7 wherein the ratio of polyurethane and MEK is between 30:70 to 55:45.

9. Insulation according to claim 6 further comprising a second layer of fiberfill padding.

10. Insulation according to claim 6 further comprising a second layer of membrane.

11. A method for creating insulation comprising:
selecting fiberfill padding for one layer;
selecting a membrane for a second layer;
positioning the fiberfill padding and membrane for assembly;
selecting an adhesive;
applying the adhesive to the surface of one layer;
laying the second layer on top of the layer with adhesive.

12. A method according to claim 11 wherein the fiberfill padding is a minimum of 90% Polyester and the membrane is a minimum of 50% Polyester content.

13. A method according to claim 12 wherein the adhesive is polyurethane melted using a solvent.

14. A method according to claim 13 wherein the solvent is MEK

15. A method according to claim 14 wherein the ratio of polyurethane and MEK is between 30:70 to 55:45.

16. A method for creating insulation according to claim 8 comprising;
positioning the fiberfill padding and membrane for assembly;
applying the adhesive to a top surface of the membrane;
laying the fiberfill padding on top of the adhesive on the membrane.
